(19) United States
(12) Patent Application Publication
(10) Pub. No.: US 2003/0206518 A1
(43) Pub. Date: Nov. 6, 2003

(54) Public access separation in a virtual networking environment

(76) Inventors: James Ching-Shau Yik, Mission Viejo, CA (US); Eric Lin, Hacienda Heights, CA (US)

Correspondence Address: TUCKER, ELLIS & WEST LLP, 1150 HUNTINGTON BUILDING, 925 EUCLID AVENUE, CLEVELAND, OH, 44115-1475, US

(21) Appl. No.: 09/865,592

(22) Filed: May 25, 2001

(51) Int. Cl. H04J 1/16

(52) U.S. Cl. 370/230; 370/235

(57) ABSTRACT

A method of forwarding payload data units in a virtual networking environment is presented. The method enables a data switching node to separate public access data traffic from private access data traffic. The method further assigns a predefined level of service to public access data traffic. The advantages lie in enabling a multi-port data network node to convey both public and private data traffic with assistance from management software. Improperly configured network devices connected to public access points, whether intentionally or unintentionally, are prevented from affecting data transport performance of the data networking environment in which they participate.

### FIELD OF THE INVENTION

The invention relates to data networking, and in particular to methods of differentiating public access from private access to data services in a virtual data networking environment.

### BACKGROUND OF THE INVENTION

Virtual data networking enables virtual collocation of data network nodes connected to data network segments associated with multiple sites separated by large geographical distances. In particular virtual data networking enables all participating data networking nodes in a Virtual Local Area Network (VLAN) to communicate to each other as if they were part of the same data network segment.

In the field of virtual data networking, data switching equipment such as data switching nodes forward Payload Data Units (PDUs) based on information held in PDU headers. Processing of PDUs at data switching nodes can be prioritized based on a forwarding priority specified in a VLAN forwarding priority field of a PDU header.

Typically the VLAN forwarding priority field is inserted in the PDU header by a source data network node generating the PDU and participating in a virtual data networking environment. The VLAN forwarding priority specification is used to indicate a Class-of-Service (CoS) required to reserve network resources in enabling the provision of a service. Typically the VLAN forwarding priority information is honored by nodes participating in the data networking environment.

Virtual data networking also enables portable data network nodes to connect via data network access points to different segments of the same VLAN without need for reconfiguration. Portable data network nodes, such as laptops, but not limited thereto, enable a better collaboration between users as the users have the ability to meet in conference type environments while still having access to data network resources.

In a corporate environment served by a private VLAN where control can be exercised over every data network node, data transport in the virtual networking environment can be provisioned optimally in accordance with predetermined service level guarantees.

Typically, corporate environments also provide complimentary access to data services from public access points such as are typically made available in conference rooms to visiting users. Typically visiting data network equipment, including portable data network nodes, web appliances, etc., connecting to public access points benefit only from a minimal configuration and little if any control can be exercised over them. Visiting data network nodes can therefore request access to the data services with high CoS requirements such as high forwarding priorities. As a result, the performance of the data network can be negatively impacted.

Currently, aside from business disruptive extra time devoted to the configuration of visiting data network nodes there are no known modes of protecting a data networking environment from an abuse of data network resources by the visiting node.

There therefore is a need to provide methods and apparatus for differentiating and effecting network-centric control over data traffic originating at public access points.

### SUMMARY OF THE INVENTION

In accordance with an aspect of the invention, a data network node enforcing flow control in forwarding data traffic over data networking facilities of a private data networking environment is provided. The data network node forwards data traffic according to data traffic conveyance characteristics detailed in service level specifiers associated with input ports. Selected input ports may be designated as public access ports whose data traffic flow is to be regulated to protect against abuse of the resource of the private networking environment.

In accordance with another aspect of the invention, a method of enforcing control in forwarding data traffic over data networking facilities of a private data networking environment is provided. The forwarding of data traffic is done according to a service level specification associated therewith—a predetermined level of service being selectively ascribed to conveyed data traffic associated with an input port designated as conveying public access data traffic. The assignment of the predetermined level of service to the public access data traffic prevents an abuse of resources of the private data networking environment.

The advantages are derived from a data switching node being adapted to operate in both private and public virtual networking environments preventing an abuse of data network resources by visiting data network nodes. Any improperly configured data network node connected to a public access point, intentionally or unintentionally, cannot affect the performance of the virtual data networking environment in which it participates.

### BRIEF DESCRIPTION OF THE DRAWINGS

The features, and advantages of the invention will become more apparent from the following detailed description of the preferred embodiment with reference to the attached diagrams wherein:

FIG. 1 is a schematic diagram showing network elements participating in a virtual data networking environment having private and public access points in accordance with an embodiment of the invention;

FIG. 2 is a schematic diagram showing an exemplary control mechanism enforcing controlled access to data network services in accordance with an exemplary implementation of the invention;

FIG. 3 is a schematic diagram showing another exemplary control mechanism enforcing controlled access to data network services in accordance with another exemplary implementation of the invention; and

FIG. 4 is a flow diagram showing process steps enforcing controlled access to data network services in accordance with an exemplary embodiment of the invention.

It will be noted that like features bear similar labels.

### DETAIL DESCRIPTION OF THE EMBODIMENTS

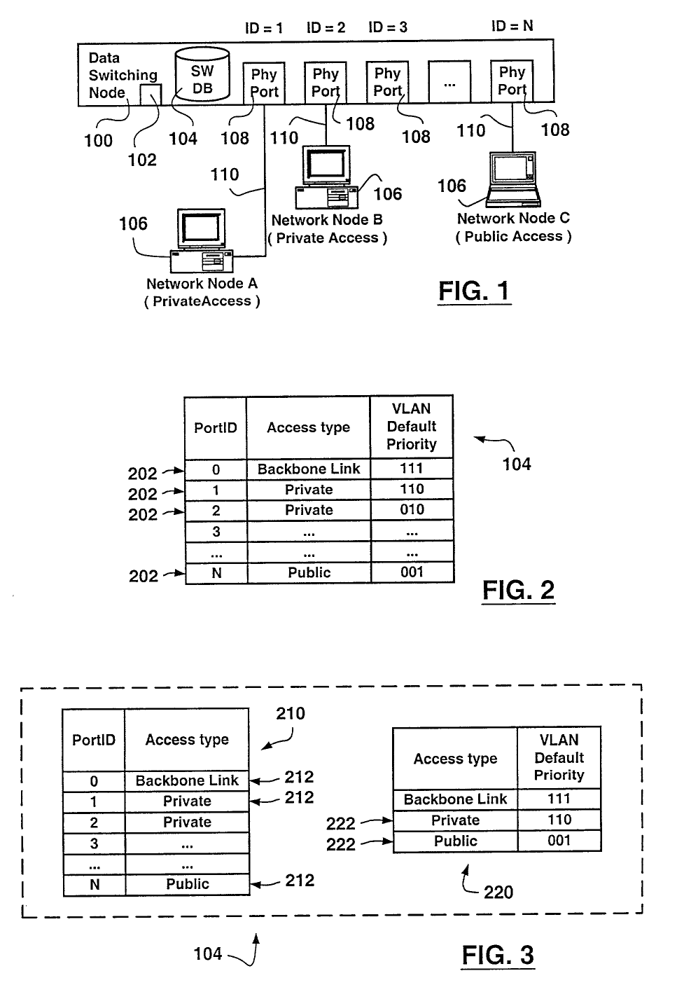

FIG. 1 is a schematic diagram showing network elements participating in a virtual data networking environment having private and public access points in accordance with an embodiment of the invention.

A data switching node 100, having a controller 102, maintains a SWitching DataBase (SW DB) 104. The SW DB 102, a detail of which will be presented below with reference to FIG. 2 and FIG. 3, stores a current configuration (topology) of data network segments connected to the data switching node 100 and other information necessary to enforce data flow control. The topology information stored in the SW DB 104 specifies which data network node 106 is connected to which physical port 108. Data network node configurations exist (not shown) in which more than one data network node 106 is connected to a physical port 108 as data network segments may have more than one data network node such as bus-network segments, ring-network segments, etc. Individual data network nodes 106 connect to an individual physical port 108 via a dedicated communications link such as a network cable 110.

The data switching node 100 is shown to operate in a virtual data networking environment having private and public access points (not shown). In particular, data network nodes 106-A and 106-B connect to private access points. Data network node 106-C is a visiting data network node connecting to a public access point.

A system administrator designates certain data access points, such are provided in conference rooms but not limited thereto, as public access points. Any PDU received on an input port associated with the public access points is processed in accordance with a predefined VLAN forwarding priority by replacing the forwarding priority specification in the header of such a PDU. Alternatively if a received PDU does not have a VLAN designation, a VLAN header information and a VLAN designation is added to the header of the PDU bearing a predefined forwarding priority.

FIG. 2 is a schematic diagram showing an exemplary control mechanism enforcing controlled access to data network services in accordance with an exemplary implementation of the invention.

The control access mechanism 104 is exemplified by a lookup table which represents a portion of the switching database. The lookup table has access control entries 202 specifying an access type for each port and an associated VLAN default forwarding priority.

FIG. 3 is a schematic diagram showing another exemplary control mechanism enforcing controlled access to data network services in accordance with another exemplary implementation of the invention.

The control access mechanism 104 is exemplified by a port access type lookup table 210 and a default forwarding priority lookup table 220. The access type lookup table 210 stores access type designations specified in table entries 212 for each port. The default forwarding priority lookup table 220 stores default forwarding priorities specified in table entries 222 for each access type. Although the invention will be described making reference to the lookup tables 104, 210 and 220 as access control mechanisms, the invention is not limited thereto and applies equally well other implementations of access control mechanisms.

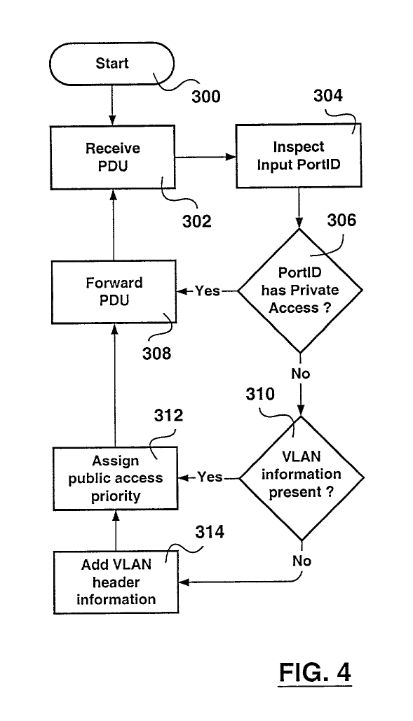

FIG. 4 is a flow diagram showing process steps enforcing controlled access to data network services in accordance with an exemplary embodiment of the invention.

The switching process is initiated in step 302 with the receipt of a PDU at the data switching node 100. The input PortID is determined in step 304. Typically in processing the PDU, the PDU is queued in an input buffer associated with the input port on which the PDU was received. The access type for the identified PortID is determined in step 306.

If the determined access type is “private”, then the process forwards the PDU in step 308 and resumes from step 302.

If the determined access type is “public”, the process inspects the PDU for any existing VLAN information in step 310.

If VLAN information is found in the PDU header in step 310, the process assigns, in step 312, a default forwarding priority specified via the control mechanism 104 and the process resumes from step 308. The default forwarding priority may be specified by a system administrator as mentioned above.

If the PDU header is not found to include VLAN information, VLAN specific headers are added to the PDU in step 314 and the process resumes from step 312. The added PDU headers bear the default forwarding priority specified via the control mechanism 104.

The advantages provided by the invention lie in that any improperly configured data network node connected to a public access point, intentionally or unintentionally, cannot affect the performance of the virtual data networking environment in which it is allowed to participate.

The invention was described with reference to the an embodiment in which control over public access data transfers in a private networking environment is effected at layer 2 of the Open Systems Interconnect (OSI) standard hierarchy. The invention is not limited thereto and embodiments may be implemented which effect control over public access data transfers in a private networking environment at other OSI layers with out departing from the spirit of the invention. Benefits derived from an implementation effecting control over public access data transfers in a private networking environment at OSI layer 3, include support for Differentiated Services. A Differentiated Services implementation would enable control over a service level provided for public access data traffic in a private networking environment via a wider group of data traffic flow shaping criteria than just the above presented forwarding priority criteria.

The embodiments presented are exemplary only and persons skilled in the art would appreciated that variations to the above described embodiments may be made without departing from the spirit of the invention. The scope of the invention is solely defined by the appended claims.

We claim:

1. A data network node enforcing flow control in forwarding data traffic over data networking facilities of a private data networking environment, the data network node comprising:
a. at least one input port; and
b. a service level specifier associated with the at least one input port specifying a predetermined level of service for the conveyance of public access data traffic.

2. A data network node as claimed in claim 1, wherein the service level specifier further designates the at least one input port as an input port conveying public access data traffic.

3. A data network node as claimed in claim 2, wherein the data network node is a data switching node having a plurality of input ports.

4. A data network node as claimed in claim 3, wherein each one of the plurality of input ports is associated one of a plurality of service level specifiers.

5. A data network node as claimed in claim 4, wherein the plurality of service level specifiers are stored in a lookup table.

6. A data network node as claimed in claim 5, wherein the lookup table is included in a switching database associated with the data network node.

7. A method of enforcing flow control in forwarding data traffic over data networking facilities of a private data networking environment, the method comprising steps of:
a. selectively assigning a predetermined level of service to a Payload Data Unit (PDU) if an input port on which the PDU was received is designated as conveying public access data traffic; and
b. forwarding the PDU according to the level of service associated therewith.

8. A method as claimed in claim 7, wherein prior to assigning the predetermined level of service to the PDU, the method further comprises a step of determining the input port on which the PDU was received, from a plurality of input ports of a multi-port data network node.

9. A method as claimed in claim 8, wherein assigning the predetermined level of service the method further comprises a step of querying a database using as a key an input port identifier associated with the input port.

10. A method as claimed in claim 8, wherein assigning a predetermined level of service to the PDU, the method further comprises a step of determining the access type associated with the input port.

11. A method as claimed in claim 10, wherein determining the access type ascribed to the input port the method further comprises a step of querying a database using as a key an input port identifier associated with the input port.

12. A method as claimed in claim 10, wherein assigning a predetermined level of service to the PDU, the method further comprises a step of determining the predetermined level of service.

13. A method as claimed in claim 12, wherein determining the predetermined level of service, the method further comprises a step of querying a database using as a key an input port identifier associated with the input port.

14. A method as claimed in claim 12, wherein determining the predetermined level of service, the method further comprises a step of querying a database using as a key the access type associated with the input port.
